(19) United States
(12) Patent Application Publication
(10) Pub. No.: US 2012/0100055 A1
(43) Pub. Date: Apr. 26, 2012

(54) CHEMICAL LOOPING AIR SEPARATION UNIT AND METHODS OF USE

(76) Inventor: Justin M. Weber, Morgantown, WV (US)

(21) Appl. No.: 12/909,683

(22) Filed: Oct. 21, 2010

(51) Int. Cl. B01D 53/46

(52) U.S. Cl. 423/219

(57) ABSTRACT

The disclosure provides for oxygen separation from air by utilizing an initial oxygen carrier which undergoes an endothermic reduction reaction to produce a carrier product and gaseous oxygen. The gaseous oxygen is withdrawn, and the carrier product is subsequently further reduced with a fuel in a combustion process, releasing heat and generating a oxygen acceptor. The oxygen acceptor is oxidized in an exothermic reaction. The method thus couples the exothermic oxidation reaction, the endothermic reduction reaction, and the chemical energy supplied by the fuel for a net heat release. In an embodiment, the initial oxygen carrier is CuO, the carrier product is Cu₂O, and the oxygen acceptor is Cu.

### GOVERNMENT INTERESTS

The United States Government has rights in this invention pursuant to the employer-employee relationship of the Government to the inventors as U.S. Department of Energy employees and site-support contractors at the National Energy Technology Laboratory.

### FIELD OF THE INVENTION

One or more embodiments provides for oxygen separation from a gaseous mixture such as air by utilizing an initial oxygen carrier which undergoes an endothermic reduction reaction to produce a carrier product and gaseous oxygen. The gaseous oxygen is withdrawn, and the carrier product is subsequently further reduced with a fuel generating an oxygen acceptor. The oxygen acceptor is oxidized in an exothermic reaction. The method thus couples the exothermic oxidation reaction, the endothermic reduction reaction, and the chemical energy supplied by the fuel for a global exothermic reaction.

### BACKGROUND

Oxygen is heavily utilized in various technological processes and industries, including metallurgical industries, chemical synthesis, glass manufacturing, pulp and paper industry, petroleum recovery/refining, and health services. Additionally, advanced power generation systems such as integrated gasification combined cycle (IGCC), oxyfuel combustion, and solid oxide fuel cells (SOFCs) utilize generated oxygen. Typically, oxygen is produced at industrial scales through cryogenic distillation, which exploits the difference of relative volatilities of oxygen and nitrogen, through membrane separation, which takes advantage of the difference in solubility and diffusivity of oxygen and nitrogen in membranes, or through gas adsorption, which utilizes the preferential adsorption of one component over the other on solid sorbents, either by equilibrium or by kinetics.

Another method of separating oxygen from air relies on cyclic oxidation and reduction of an oxygen carrier, such as a metallic oxide. In typical chemical looping air separation methods, oxygen is separated from a flow of air by utilizing oxidation and reduction reactions similar to equations (1) and (2) below:

(oxidation) MeₓO_{y-1}(s)+½O₂(g)→MeₓO_{y}(s) (1)

(reduction) MeₓO_{y}(s)→MeₓO_{y-1}(s)+½O₂(g) (2)

where Meₓ denotes the oxygen carrier, such as a metal oxide. Typically MeₓO_{y-1}, O₂, and MeₓO_{y} represent a chemical system having an equilibrium at a temperature and oxygen partial pressure, and the oxygen partial pressure may be varied between oxidizing and reducing reactors in order to drive the reaction in the desired direction. In the oxidizing reactor, the flow of air provides a partial pressure of oxygen sufficient to produce equation (1) as the predominant reaction, and in the reducing reactor, an inert sweeping gas such as steam displaces the gaseous oxygen generated and maintains a partial pressure of oxygen sufficient to produce equation (2) as the predominant reaction. The oxygen generated discharges with the sweeping gas and may be subsequently separated from the sweeping gas for a higher purity oxygen stream. See e.g., Moghtaderi, “Application of Chemical Looping Concept for Air Separation at High Temperatures,” Energy Fuels, Vol. 24 (2010).

An arrangement utilizing equations (1) and (2) as described can have relatively low energy demands, because the theoretical net heat released over equations (1) and (2) is zero. In theory, therefore, an exothermic reaction in the oxidation reactor may provide the heat duty necessary to drive an endothermic reaction in the reducing reactor, or vice-versa. In practice this can be partially accomplished by exchanging heat between various streams in the process, however some heat is invariably lost in the process, and additional thermal energy must be provided by, for example, input electrical power. See e.g. Moghtaderi; see also U.S. Pat. No. 4,746,502, issued to Erickson, issued May 24, 1988, among others. This requirement is exacerbated as the range of equilibrium temperatures for the oxygen carrier increases, and sizable heating and/or cooling loads are demanded in order to cover a range of oxygen partial pressures of interest.

It would be advantageous to provide a method of separating oxygen from air in a manner where net heat production resulted as a result of the operative oxidation and reduction reactions, in order to mitigate requirements for additional thermal energy.

It is known that interactions between oxygen carriers and a fuel in the process known as chemical looping combustion can produce and release exothermic heat. In chemical looping combustion systems, an oxygen carrier experiences such a reducing reaction in a fuel reactor, and the oxygen-depleted carrier is cycled to an air reactor and subjected to a flow of air, in order to undergo oxidation and regenerate the carrier. The total amount of heat provided by the two reactions in the chemical looping process is the same as in conventional combustion, however the potential reversibility leads to much lower exergy destruction. Chemical looping combustion is of interest for a variety of reasons including increased efficiency, CO₂ capture, and NOx suppression, however the fuel and oxygen carrier reaction consumes oxygen carried by the oxygen carrier for the production of the combustion products, and as such does not lend itself standing alone to oxygen production based on air separation. It would be advantageous to provide a method of separating oxygen from air in a manner where energy could be produced as a result of linking the operative oxidation and reduction reactions to an efficient and thermodynamically reversible process, such as the further reduction of the oxygen-depleted carrier with a fuel. Such a system would provide for a global exothermic reaction by integrating the chemical energy of the fuel for a further reduction following the oxygen-producing first reduction, as well as producing additional heat for the overall process.

Accordingly, it is an object of this disclosure to provide a method of separating oxygen from a gaseous mixture such as air utilizing the cyclic oxidation and reduction of an oxygen carrier, in order that an exothermic oxidation may provide the heat duty required for an endothermic reduction.

It is a further object of this disclosure to provide a method of separating oxygen from a gaseous mixture utilizing the cyclic oxidation and reduction of an oxygen carrier in a manner that produces a global exothermic reaction, in order to mitigate additional thermal energy requirements required to compensate for heat loss during the process.

It is a further object of this disclosure to produce net heat in the cyclic oxidation and reduction of an oxygen carrier by conducting a further reduction of the oxygen carrier following gaseous oxygen release, such that the exothermic heat released during oxidation exceeds the endothermic heat duty during reduction, producing the global exothermic reaction.

It is a further object of this disclosure to provide for the further reduction of the oxygen carrier and the net heat production of the cycle by using a process with a high degree of reversibility, thereby increasing the efficiency of the process.

It is a further object of this disclosure to provide for the further reduction and net heat production by conducting the further reduction with a fuel, thereby integrating the chemical energy of the fuel with the operative oxidation and reduction steps in the cyclic process.

These and other objects, aspects, and advantages of the present disclosure will become better understood with reference to the accompanying description and claims.

### SUMMARY

The method utilizes an initial oxygen carrier comprised of oxygen and having a chemical equilibrium with gaseous oxygen and a carrier product at specific temperature and oxygen partial pressure conditions, where the carrier product is further comprised of oxygen. In an embodiment, the initial oxygen carrier is CuO and the carrier product is Cu₂O. The initial oxygen carrier is transferred to a reducing reactor and subjected to an oxygen partial pressure below the equilibrium partial pressure of oxygen over the initial oxygen carrier, releasing gaseous oxygen and producing the carrier product endothermic reaction. A sweeping gas displaces gaseous oxygen generated in the reducing reactor and acts to maintain the oxygen partial pressure below the equilibrium partial pressure of oxygen as the gaseous oxygen is produced. A mixture of gaseous oxygen and the sweeping gas is discharged from the reducing reactor.

The carrier product is transferred to a fuel reactor. The fuel reactor further receives a flow of fuel, which acts to further reduce the carrier product to a oxygen acceptor and combustion products in a chemical combustion reaction. In an embodiment, the carrier product is Cu₂O, the oxygen acceptor is Cu, and the fuel is a hydrocarbon fuel such as CH₄. In terms of the initial oxygen carrier, the oxygen acceptor is comprised of the initial oxygen carrier less the oxygen consumed by the reduction reaction in the reducing reactor, and less the oxygen consumed in the fuel reaction of the fuel reactor.

The oxygen acceptor is transferred to an oxidizing reactor receiving a flow of a gaseous mixture comprised of oxygen such as air, and the oxygen acceptor is regenerated back to the initial oxide carrier. The additional reduction utilizing the chemical energy of the fuel provides for an exothermic oxidation reaction producing a greater amount of heat than that required by the endothermic reduction reaction. Heat produced by the combustion reaction in the second reduction may also contribute to net heat production over the cyclic process.

The further reduction of the carrier product utilizing the chemical energy of the fuel provides for an oxidation reaction generating an exothermic heat that exceeds the heat duty required by the endothermic reduction reaction. The fuel reactor may produce additional heat in the cyclic process.

In an embodiment where the initial oxygen carrier is CuO, the carrier product is Cu₂O, the oxygen acceptor is Cu, and the regenerated acceptor is CuO, the oxidation and reduction temperature is from about 850° C. to about 1150° C., and where the partial pressure of oxygen in the reducing reactor is less than about 76 Torr.

In another embodiment, the sweeping gas is comprised of CO₂, and an oxidizer stream comprised of O₂ and CO₂ is discharged from the reducing reactor to the combustion zone of an oxy-fuel combustor. The oxy-fuel combustor further receives a carbonaceous fuel, and combustion of the carbonaceous fuel with the oxidizer stream produces a flue gas stream comprised of CO₂. Some portion of the flue gas stream is recirculated and utilized as the sweeping flow in the reducing reactor in the cyclic process.

The method thus provides for oxygen separation from a gaseous mixture such as air by utilizing an initial oxygen carrier which undergoes an endothermic reduction reaction to produce a carrier product and gaseous oxygen, where the carrier product produced is further comprised of oxygen. The carrier product is subsequently further reduced with a fuel in a combustion process, releasing heat and generating a oxygen acceptor, where the oxygen acceptor is comprised of the carrier product less the oxygen consumed in the chemical combustion. By this process, chemical energy supplied by the fuel mitigates the heat duty that would otherwise be required to reduce the initial oxygen carrier to the oxygen acceptor in a purely thermal decomposition. The oxygen acceptor is then oxidized in an exothermic reaction to generate a regenerated acceptor having the same chemical composition as the initial oxygen carrier. As a result, the exothermic oxidation reaction releases heat exceeding the heat duty required by the endothermic reduction reaction. The embodiment thus couples the exothermic oxidation reaction, the endothermic reduction reaction, and the chemical energy supplied by the fuel for a global exothermic reaction.

The novel process and principles of operation are further discussed in the following description.

### BRIEF DESCRIPTION OF THE DRAWINGS

FIG. 1 illustrates an equilibrium phase diagram of a CuO—Cu₂O—Cu system.

FIG. 2 illustrates a cyclic oxidation-reduction cycle for the production of oxygen integrating the chemical energy of a fuel.

FIG. 3 illustrates a net heat production in the cyclic oxidation-reduction cycle.

### DETAILED DESCRIPTION

The following description is provided to enable any person skilled in the art to use the invention and sets forth the best mode contemplated by the inventor for carrying out the invention. Various modifications, however, will remain readily apparent to those skilled in the art, since the principles of the present invention are defined herein specifically to provide a process whereby oxygen may be separated from a gaseous mixture such as air in a manner where net heat is produced by linking the operative oxidation and reduction reactions with a further reduction of the oxygen carrier using a fuel.

The method utilizes an initial oxygen carrier comprised of oxygen and having a chemical equilibrium with gaseous oxygen and a carrier product at specific temperature and oxygen partial pressure conditions, where the carrier product is further comprised of oxygen. The initial oxygen carrier is transferred to a reducing reactor and subjected to an oxygen partial pressure below the equilibrium partial pressure of oxygen over the initial oxygen carrier, such that the gaseous oxygen and the carrier product is produced in an endothermic reaction. A sweeping gas displaces gaseous oxygen generated in the reducing reactor and acts to maintain the oxygen partial pressure below the equilibrium partial pressure of oxygen as the gaseous oxygen is produced. As a result, a significant proportion of the initial oxygen carrier reduces to gaseous oxygen and the carrier product. A mixture of gaseous oxygen and the sweeping gas is discharged from the reducing reactor.

The carrier product is transferred to a fuel reactor. The fuel reactor further receives a flow of fuel, which acts to further reduce the carrier product to a oxygen acceptor and combustion products in a chemical combustion reaction. In terms of the initial oxygen carrier, the oxygen acceptor is comprised of the initial oxygen carrier less the oxygen consumed by the reduction reaction in the reducing reactor, and less the oxygen consumed in the combustion reaction of the fuel reactor.

The oxygen acceptor is transferred to an oxidizing reactor receiving a flow of a gaseous mixture comprised of oxygen, such as air, and the oxygen acceptor is regenerated back to the initial oxide carrier. The additional reduction utilizing the chemical energy of the fuel provides for an exothermic oxidation reaction producing a greater amount of heat than that required by the endothermic reduction reaction. Heat produced by the combustion reaction in the second reduction may also contribute to net heat production over the cyclic process.

Within this disclosure, the term “initial oxygen carrier” means a solid chemical compound comprised of oxygen, where the initial oxygen carrier has a chemical equilibrium with gaseous oxygen and a carrier product, such that under reducing temperature and O₂ partial pressure conditions, the initial oxygen carrier produces the gaseous oxygen and the carrier product in a reduction reaction, and such that under oxidizing temperature and O₂ partial pressure conditions, the gaseous oxygen and the carrier product produce the initial oxygen carrier in an oxidation reaction. When in chemical equilibrium, concentrations of the initial oxygen carrier, the oxygen gas, and the carrier product respond according to Chatelier's principle, so that when the chemical system at equilibrium experiences a change in concentration, temperature, volume, or partial pressure, the equilibrium shifts to counteract the imposed change and new concentrations are established, as is understood in the art. Within this disclosure, initial oxygen carriers include but are not limited to metal oxides such as CuO, Mn₂O₃, and Co₃O₄.

Within this disclosure, the term “carrier product” means a solid chemical compound comprised of oxygen and produced in addition to gaseous oxygen as a result of the reduction reaction of an initial oxygen carrier under appropriate temperature and O₂ partial pressure conditions, where the carrier product may be further reduced in a combustion reaction with a fuel. The carrier product is comprised of the initial oxygen carrier less the gaseous oxygen produced by the reduction reaction. Within this disclosure, carrier products include but are not limited to metal oxides such as Cu₂O, Mn₃O₄, and CoO.

Within this disclosure, the term “oxygen acceptor” means a product produced in a reducing reaction between a carrier product and a fuel, where the carrier product is comprised of oxygen, and where the reducing reaction consumes oxygen comprising the carrier product. The reducing reaction may be a complete combustion producing primarily the oxygen acceptor, CO₂, and H₂O, or the reducing reaction may be a partial combustion process producing primarily the oxygen acceptor, H₂, and CO₂. The oxygen acceptor is comprised of the carrier product less the oxygen consumed in the reducing reaction between the carrier product and the fuel. Further, in an environment of sufficient temperature and O₂ partial pressure, the oxygen acceptor reacts with gaseous oxygen to produce a regenerated carrier, where the regenerated carrier has the properties of an initial oxygen carrier as defined herein.

Within this disclosure, the term “equilibrium partial pressure of oxygen” refers to a partial pressure of oxygen over a chemical compound comprised of oxygen, where the chemical compound has a chemical equilibrium with gaseous oxygen and a product, and where the equilibrium partial pressure of oxygen maintains the chemical equilibrium among the chemical compound, the gaseous oxygen, and the product at a given temperature.

Within this disclosure, the term “global exothermic reaction” means a combination of reactions including the reduction of an initial oxygen carrier to produce gaseous oxygen and a carrier product, the reduction of the carrier product with a fuel to produce an oxygen acceptor, and the oxidation of the oxygen acceptor with gaseous oxygen to produce a regenerated carrier, where the regenerated carrier has the properties of the initial oxygen carrier, and where the combination of reactions produces exothermic heat.

In typical chemical looping air separation methods, oxygen is separated from a flow of air by utilizing oxidation and reduction reactions similar to equations (1) and (2). Typically, the oxygen partial pressure is varied between oxidizing and reducing reactors in order to drive the reaction in a desired direction. In the oxidizing reactor, the flow of air provides a partial pressure of oxygen sufficient to produce equation (1) as the predominant reaction, and in the reducing reactor, an inert sweeping gas such as steam displaces the gaseous oxygen generated and maintains a partial pressure of oxygen sufficient to produce equation (2) as the predominant reaction. The arrangement has low energy demands because the theoretical net heat released over equations (1) and (2) is zero, however some heat is invariably lost in the process, and additional thermal energy must be provided by, for example, input electrical power.

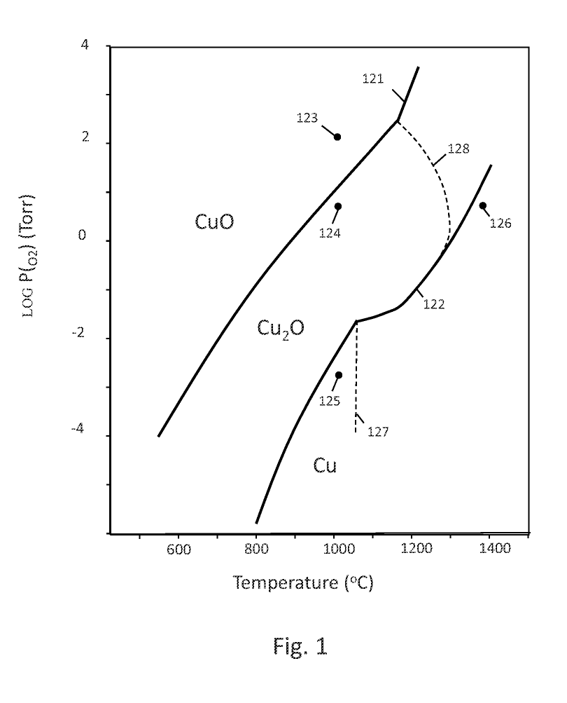

A process utilizing equations (1) and (2) may be represented at FIG. 1. FIG. 1 represents a phase equilibrium diagram for a copper oxide system and gaseous oxygen, illustrating CuO, Cu₂O, and Cu regions as a function of temperature and oxygen partial pressure, shown as LOG P_{(O2)}. For a given temperature, for oxygen partial pressures above boundary 121, the copper oxide exists as CuO. Between boundaries 121 and 122, the copper oxide exists as Cu₂O. Below boundary 122, base metal Cu results. At FIG. 1, point 123 represents CuO at a temperature of approximately 1000° C., and an oxygen partial pressure of approximately 160 Torr, representing a 21% oxygen atmospheric condition. In the system as described, for a constant temperature process, the oxygen partial pressure may be reduced by, for example, a sweeping gas in the reducing reactor. The pressure reduction drives CuO at point 122 to Cu₂O at point 123 in an endothermic reduction reaction, releasing gaseous oxygen via equation (2). The Cu₂O at point 123 may be transferred to an oxidation reactor and subjected to an atmospheric flow of air, in order to increase the oxygen partial pressure and regenerate the Cu₂O back to CuO at point 122 in an exothermic oxidation reaction via equation (1). As is understood, the net heat produced in such an operation is zero.

The oxygen partial pressure could be further reduced to produce Cu at point 125, releasing additional oxygen. However, the net heat output in returning to CuO at point 123 will remain theoretically zero, and in an actual process, will most likely require additional input thermal energy. The oxygen partial pressure necessary to achieve reduction to Cu in such a pressure swing process is also significantly reduced and can present formidable technical complexity. Alternatively, temperature could be increased to produce Cu at point 126, or some combination of pressure reduction and temperature increase could be utilized to produce Cu, however temperatures greater than approximately 1083° C., indicated by boundary 127, are beyond the melting point of Cu, and would present significant technical challenge. Similar considerations arise from boundary 128, representing the melting temperature of Cu₂O.

As a result, the typical air separation system generating gaseous oxygen through reactions such as equations (1) and (2) would operate between points 123 and 124, with a heat release of theoretically zero between the reactions, and a practical requirement for input energy to compensate for heat losses in the real system.

The method as described here overcomes this fundamental limitation by generating oxygen utilizing an initial oxygen carrier such as CuO in a reducing reactor, and followed by a further reduction utilizing a fuel. In the reducing reactor, the initial oxygen carrier releases gaseous oxygen and produces a carrier product comprised of oxygen, such as Cu₂O. The reaction in the reducing reactor is endothermic, and requires a heat input sufficient to drive the initial oxygen carrier from a state such as point 123 to a reduced state such as point 124. A sweeping gas in the reducing reactor maintains the partial pressure of oxygen below the equilibrium partial pressure of oxygen over the initial oxygen carrier, and acts to displace the gaseous oxygen generated from the reducing reactor. Following the reduction, the carrier product enters a fuel reactor and is further reduced by a fuel to produce an oxygen acceptor, such as Cu. Following the combustion, the oxygen acceptor is transferred to an oxidation reactor and subjected to a flow of a gaseous mixture comprised of oxygen, such as air. The flow of the gaseous mixture provides a partial pressure of oxygen sufficient to oxidize the oxygen acceptor in an exothermic reaction and drive regeneration back to the initial oxygen carrier. The process is generally approximated by reactions (3), (4), and (5) below:

MeₓO_{y}(s)→MeₓO_{y-1}(s)+½O₂(g) (3)

CₙH₂ₘ+(2n+m)MeₓO_{y-1}→nCO₂+mH₂O+(2n+m)MeₓO_{y-2} (4)

MeₓO_{y-2}(s)+O₂(g)→MeₓO_{y}(s) (5)

In the reactions above, the initial oxygen carrier of the method disclosed is represented by MeₓO_{y}, the carrier product is represented by MeₓO_{y-1}, and the oxygen acceptor is represented by MeₓO_{y-2}, where y is equal to or greater than 2. The fuel in reaction (4) is represented as a hydrocarbon fuel. Within the method presented here, gaseous oxygen is released via reaction (3) in an endothermic reaction, the carrier product is further reduced by the chemical energy of the fuel via reaction (4), and the oxygen acceptor is oxidized via reaction (5) in an exothermic reaction. As is understood, the exothermic heat released via reaction (5) exceeds the endothermic heat duty requirement of reaction (3). The process thereby provides separation of oxygen from a gaseous mixture comprised of oxygen, such as air, in a regenerating, cyclic process with a global exothermic reaction, by utilizing the chemical energy of the fuel to facilitate a further reduction of the carrier product. In an embodiment, the initial oxygen carrier is CuO, the carrier product is Cu₂O, the oxygen acceptor is Cu, the fuel is CH₄, and the oxidation and reduction temperatures are approximately 1000° C. In this embodiment, with reference to FIG. 1, the theoretical net heat released is equivalent to the difference between the endothermic reaction from point 123 to point 124 and the exothermic reaction from point 125 to point 123, in addition to any heat released in the further reduction via reaction (4).

In reaction (4) above, the fuel is represented as the hydrocarbon fuel CₙH₂ₘ, however, the composition of the fuel is not limiting within the method. Within the method disclosed, it is only necessary that the fuel cause a further reduction of the carrier product to produce the oxygen acceptor.

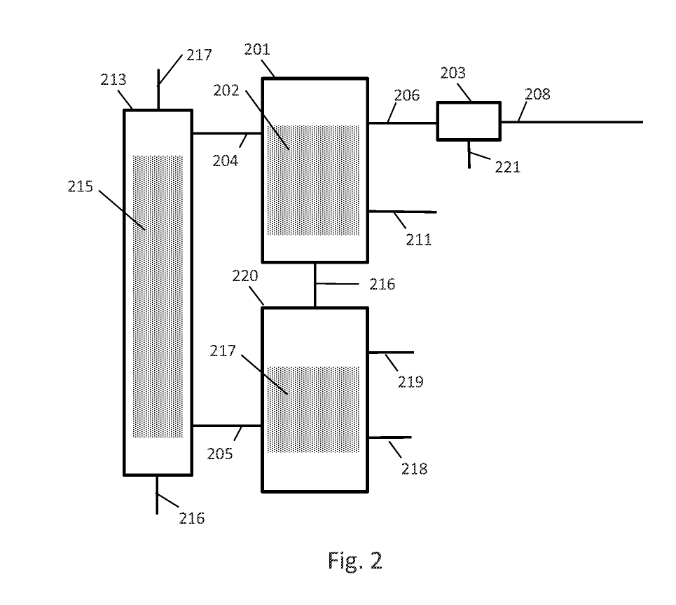

The method is further illustrated at FIG. 2. FIG. 2 illustrates reducing reactor 201 containing an initial oxygen carrier 202. Reducing reactor 201 is maintained at a reducing temperature sufficient to generate a reduction reaction, where the reduction reaction reduces initial oxygen carrier 202 to gaseous oxygen and a carrier product in a reaction similar to reaction (3). Further, the reducing temperature is less than the pyrolysis temperatures of the initial oxygen carrier and the carrier product. As previously discussed, initial oxygen carrier 202, the gaseous oxygen, and the carrier product will establish equilibrium concentrations at the reducing temperature when the liberated oxygen reaches a concentration sufficient to generate the equilibrium partial pressure of oxygen over initial oxygen carrier 202. As is understood in the art, if the partial pressure of oxygen in reducing reactor 201 is below the equilibrium partial pressure of oxygen for given concentrations of initial oxygen carrier 202, the gaseous oxygen, and the carrier product, then the concentration of initial oxygen carrier 202 will decrease via the reduction reaction to produce gaseous oxygen and carrier product.

As initial oxygen carrier 202 is maintained at the reducing temperature in reducing reactor 201, a sweeping flow comprised of an inert sweeping gas enters reducing reactor 201 at pathway 211. The sweeping flow acts to displace gaseous oxygen generated via the reduction of initial oxygen carrier 202, and a mixture of O₂ and the sweeping gas exits reduction reactor 201 as an oxygen stream at pathway 206. The displacement of the generated O₂ by the sweeping flow further acts to maintain the partial pressure of O₂ in reducing reactor 201 below the equilibrium partial pressure of oxygen for the concentrations of initial oxygen carrier 202, the gaseous oxygen, and the carrier product within reducing reactor 201. Concurrently, carrier product is removed from reduction reactor 201 via pathway 216. As a result of the reductions in the gaseous oxygen and carrier product concentrations, initial oxygen carrier 202 continues to undergo the reduction reaction for the production of gaseous oxygen and carrier product. As the reduction reaction proceeds, additional initial oxygen carrier material enters reducing reactor 201 via pathway 204 to maintain the concentration of initial oxygen carrier 202 in reducing reactor 201.

Carrier product is removed from reduction reactor 201 via pathway 216, and subsequently provided to fuel reactor 220. Fuel reactor 220 further receives a fuel stream via pathway 218. The fuel stream is comprised of a fuel which acts to further reduce the carrier product to a oxygen acceptor and combustion products in a combustion reaction similar to reaction (4), where the combustion reaction occurs at a combustion temperature less than the pyrolysis temperatures of the carrier product or the oxygen acceptor. The combustion products may be comprised primarily of the oxygen acceptor, CO₂, and H₂O, or comprised primarily of the oxygen acceptor, CO, and H₂. The oxygen acceptor is comprised of the carrier product 217 less the oxygen consumed in the combustion reaction. In terms of the initial oxygen carrier, the oxygen acceptor is comprised of the initial oxygen carrier 202 less the oxygen consumed by the reduction reaction of reducing reactor 201, and less the oxygen consumed in the combustion reaction of fuel reactor 220. Subsequent to the combustion, a combustion product stream exits fuel reactor 220 via pathway 219, and the oxygen acceptor exits fuel reactor 220 via pathway 205.

The oxygen acceptor generated in fuel reactor 220 is transferred and regenerated with a flow of air in a reaction similar to reaction (5), to be utilized as the initial oxygen carrier in a cyclic operation. At FIG. 2, carrier product exits reducing reactor 201 at pathway 205 and is transferred to oxidizing reactor 213. An air flow enters oxidation reactor 213 via pathway 216. Oxidizing reactor 213 is maintained at an oxidation temperature sufficient to generate an oxidation reaction, where the oxidation reaction oxidizes the oxygen acceptor with oxygen comprising the air flow to produce regenerated acceptor 215. Further, the oxidation temperature is less than the pyrolysis temperatures of the oxygen acceptor and the regenerated acceptor. As a result of the oxidation in oxidizing reactor 213, the regenerated acceptor 215 produced in oxidation reactor 213 has the same chemical composition as initial oxygen carrier 202.

As the oxygen acceptor is maintained at the oxidation temperature in oxidizing reactor 213, the air flow entering via pathway 216 acts to provide oxygen for the oxidation reaction as well as to displace remaining oxygen and other air components via pathway 217. The air flow introduction and the displacement of the remaining oxygen and other air components further acts to maintain the partial pressure of O₂ in oxidation reactor 213 above the equilibrium partial pressure of oxygen for the concentrations of the oxygen acceptor, the gaseous oxygen, and the regenerated acceptor within oxidation reactor 213. Concurrently, the regenerated acceptor 215 is removed from oxidizing reactor 213 via pathway 204, and transferred to reducing reactor 201 for use as initial oxygen carrier 202 in a cyclic operation.

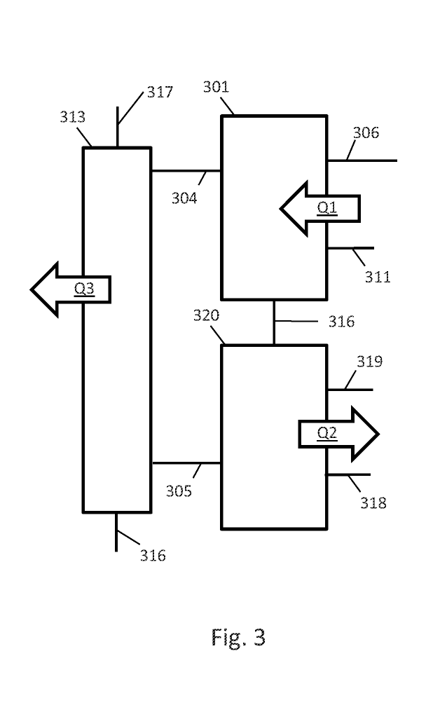

An exemplary application is discussed with reference to FIG. 3. At FIG. 3, reducing reactor 301 is maintained at a reducing temperature of about 1000° C. and a total pressure of substantially atmospheric. The initial oxygen carrier utilized is CuO, and reducing reactor 301 receives CuO at a rate of 163 kilograms per hour (kg/hr) via pathway 304. A partial pressure of oxygen over the CuO in reducing reactor 301 is maintained at approximately 10% (76 Torr) by an 80 kg/hr sweeping flow of CO₂ entering reducing reactor 301 via pathway 311. Under this oxygen partial pressure condition, the CuO reduces to a carrier product of Cu₂O and gaseous oxygen. Under the action of the sweeping flow, an oxidizer stream comprised of 6.8 kg/hr O₂ and 80 kg/hr CO₂ exits reducing reactor 301 via pathway 306. The reduction of CuO to Cu₂O and gaseous oxygen is an endothermic process requiring 15 kilowatt thermal (kWth). The heat duty for the endothermic reaction is indicated at FIG. 3 as Q1.

The Cu₂O carrier product exits reducing reactor 301 and enters fuel reactor 320 via pathway 316. Fuel reactor 320 is maintained at a combustion temperature of about 1000° C. and a total pressure of substantially atmospheric. Additionally, fuel reactor 320 receives CH₄ fuel via pathway 318 at a rate of 1 kg/hr. The combustion temperature in fuel reactor 320 is sufficient for oxygen comprising the Cu₂O to react with the CH₄, producing a oxygen acceptor, Cu. The reduction of Cu₂O to Cu is an exothermic process releasing 2.4 kWth. The heat released for the exothermic reaction is indicated at FIG. 3 as Q2.

The Cu oxygen acceptor exits fuel reactor 320 and enters oxidizing reactor 313 via pathway 305. Oxidizing reactor 313 is maintained at an oxidation temperature of about 1000° C. and a total pressure of substantially atmospheric. Additionally, oxidation reactor 313 receives a flow of air via pathway 316 at a rate of 1 kg/hr. The oxidation temperature in oxidizing reactor 313 is sufficient for Cu to oxidize with oxygen in the air flow, producing regenerated acceptor CuO. The oxidation of Cu to CuO is an exothermic process releasing 27 kWth. The heat released for the exothermic reaction is indicated at FIG. 3 as Q3. Remaining oxygen and chiefly N₂ exit oxidizing reactor 313 via pathway 317. Heat exchange between pathways 316 and 317 may be utilized to reduce heating duties for the incoming flow of air.

In the process depicted at FIG. 3, the regenerated acceptor CuO is removed from oxidizing reactor 313 via pathway 304, and transferred to reducing reactor 301 for use as the initial oxygen carrier CuO in a cyclic operation. The operation integrates the chemical energy of the fuel stream CH₄ in the reduction of CuO to Cu, and results in a net heat release of approximately 14 kWth. By this process, chemical energy supplied by the fuel mitigates the heat duty that would otherwise be required to reduce the initial oxygen carrier to the oxygen acceptor in a purely thermal decomposition. An oxygen stream of O₂ and CO₂ is thus provided in a process which generates net heat outside of that generated within the oxy-fuel combustor.

The carrier product entering fuel reactor 320 should have an affinity for the reducing reaction with the fuel gas, and preferably the oxygen acceptor produced reacts rapidly with air. The fuel stream may be a gaseous fuel such as natural gas, or may be a solid fuel such as coal provided that fuel reactor 320 is designed for initial gasification of the solid fuel. Oxygen utilized in the combustion reaction may react with the fuel through direct interaction between the carrier product and the fuel, or the oxygen may be released by the carrier product as gaseous oxygen in fuel reactor 320 prior to reaction with the fuel.

It is understood that the conditions depicted at FIG. 3 are exemplary only, and that the specifics of a given system will dictate the specific operating parameters of an embodiment such as that depicted at FIGS. 2 and 3. Within the method disclosed and depicted at FIGS. 2 and 3, it is only necessary that an initial oxygen carrier is reduced in a reducing reactor to produce a carrier product and gaseous oxygen, that a sweeping flow comprised of an inert sweeping gas maintains the partial pressure of oxygen in the reducing reactor below the equilibrium partial pressure of oxygen over the initial oxygen carrier, that an oxygen stream is discharged from the reducing reactor, that the carrier product be transferred to a fuel reactor for a combustion reaction with fuel to produce a oxygen acceptor, and that the oxygen acceptor be transferred to an oxidizing reactor to produce a regenerated acceptor, where the regenerated acceptor has the same composition as the initial oxygen carrier.

As illustrated at FIG. 2, in an embodiment the oxygen stream exiting via pathway 206 and comprised of oxygen and the sweeping gas is further separated to produce a concentrated O₂ stream at pathway 208 and a sweeping gas stream at pathway 221. For example, the sweeping gas may be steam, such that the oxygen stream at pathway 206 is comprised of oxygen and H₂O. The oxygen stream may enter a condensing unit 203 for further separation, producing concentrated O₂ stream at pathway 208 and an H₂O stream at pathway 221.

In a further embodiment, the sweeping gas entering at pathway 221 is comprised of CO₂, the oxygen stream exiting at pathway 206 is comprised of oxygen and CO₂, and the oxygen stream is discharged to the combustion zone of an oxy-fuel combustor. A fuel stream comprised of a carbonaceous fuel additionally enters the combustion zone, and the fuel stream and oxygen within the oxygen stream generate a combustion reaction, releasing heat and producing a flue gas stream comprised of CO₂. In this embodiment, some portion of the flue gas stream is diverted and utilized as the sweeping flow entering reducing reactor 201 via pathway 211. The use of oxy-fuel flue gas as the sweeping flow provides for establishing the CO₂ to O₂ ratio without reliance on additional O₂ dilution or separation steps, as may otherwise be required with non-CO₂ sweeping gases when utilizing the method herein for oxygen separation in support of an oxy-fuel combustion. The flue gas stream may undergo processing for removal of particulates, SOₓ, and other non-condensable and condensable gases prior to generation of the sweeping flow entering the reducing reactor.

As previously defined, initial oxygen carrier 202 is a solid chemical compound comprised of oxygen having a chemical equilibrium with gaseous oxygen and a carrier product, such that under a reducing temperature and O₂ partial pressure condition, initial oxygen carrier 202 releases O₂ in reducing reactor 201. Exemplary initial oxygen carriers include CuO, Mn₂O₃, and Co₃O₄. In a particular embodiment, the initial oxygen carrier is CuO, the carrier product is Cu₂O, and the oxygen acceptor is Cu. It is understood that the initial oxygen carrier, carrier product, and oxygen acceptor may be combined with an inert to act as a porous binder, enhance the reactivity of the active phase, act as an ionic conductor for oxygen, increase mechanical strength and attrition resistance, and mitigate agglomeration, among other motivations. Exemplary binders might include alumina, silica, sepiolite, titania, and zirconia, among others. Further, the initial oxygen carrier, the carrier product, and the oxygen acceptor can be provided as a plurality of particles or pellets to facilitate contact between gaseous and solid phases and to facilitate transport among, for example, an oxidizing reactor and a reducing reactor.

The oxidizing and reducing reactors may be any reactor known in the art for the establishment of contact between gaseous and solid phases, and may incorporate a rotary kiln, moving beds of particles, fluidized beds, fixed beds, or other methods known in the art. Transport of the particles or pellets between reactors may be accomplished in a variety of ways, including moving bed arrangements, fluidized transfer of pellets, and other means known to those skilled in the art. For example, a reactor may be a high velocity fluidized bed where particles are transported together with an exiting gas flow to the top of the air reactor, and then transferred to a second reactor via a cyclone. Similarly, a reactor may be bubbling fluidized bed reactor with particles transported to a second reactor by an overflow pipe.

Within the method disclosed herein, heat may be transferred between oxidizing reactor 213, reducing reactor 201, fuel reactor 220, and the various gas streams utilized or generated in order to mitigate heat duty requirements for the endothermic reduction reaction in reducing reactor 201 or provide pre-heating for the air flow entering via pathway 216, among other purposes. Heat transfer may be accomplished using various means, for example, with a heat exchanger using water as a heat transfer fluid from oxidizing reactor 213 to reducing reactor 201, through a common wall utilized by both reducing reactor 201 and oxidizing reactor 213, heat exchange between the various gas streams exiting and entering reducing reactor 201 and oxidizing reactor 213, and other means known in the art.

In an embodiment where the sweeping flow is comprised of CO₂ from the flue gas of an oxy-fuel combustor, the flue gas stream exiting the oxy-fuel combustor may be additionally utilized for power generation by providing motive force to a turbine, through heat exchange for the generation of steam, or other methods known in the art. The flue gas stream may also be subjected to various CO₂ capture methods known in the art.

The method thus provides for oxygen separation from a gaseous mixture comprised of oxygen, such as air, by utilizing an initial oxygen carrier which undergoes an endothermic reduction reaction to produce a carrier product and gaseous oxygen, where the carrier product produced is further comprised of oxygen. The carrier product is subsequently further reduced with a fuel in a combustion process, releasing heat and generating a oxygen acceptor, where the oxygen acceptor is comprised of the carrier product less the oxygen consumed in the chemical combustion. By this process, chemical energy supplied by the fuel mitigates the heat duty that would otherwise be required to reduce the initial oxygen carrier to the oxygen acceptor in a purely thermal decomposition. The oxygen acceptor is then oxidized in an exothermic reaction to generate a regenerated acceptor having the same chemical composition as the initial oxygen carrier. As a result, the exothermic oxidation reaction releases heat exceeding the heat duty required by the endothermic reduction reaction. The method thus couples the exothermic oxidation reaction, the endothermic reduction reaction, and the chemical energy supplied by the fuel for a net heat release.

Accordingly, the disclosure provides a method of separating oxygen from a gaseous mixture utilizing the cyclic oxidation and reduction of an oxygen carrier, in order that an exothermic oxidation may provide the heat duty required for an endothermic reduction.

Further, the disclosure provides a method of separating oxygen from a gaseous mixture utilizing the cyclic oxidation and reduction of the oxygen carrier in a manner that produces a global exothermic reaction, in order to mitigate additional thermal energy requirements required to compensate for heat loss during the process.

Further, the disclosure provides for net heat production in the cyclic oxidation and reduction of the oxygen carrier by conducting a further reduction following gaseous oxygen release, such that the exothermic heat released during oxidation exceeds the endothermic heat duty during reduction, producing the global exothermic reaction.

Further, the disclosure provides for the further reduction of the oxygen carrier and the net heat production of the cycle using a process with a high degree of reversibility, thereby increasing the efficiency of the process.

Further, the disclosure provides for the further reduction and net heat production by conducting the further reduction with a fuel, thereby integrating the chemical energy of the fuel with the operative oxidation and reduction steps in the cyclic process.

It is to be understood that the above-described arrangements are only illustrative of the application of the principles of the present invention and it is not intended to be exhaustive or limit the invention to the precise form disclosed. Numerous modifications and alternative arrangements may be devised by those skilled in the art in light of the above teachings without departing from the spirit and scope of the present invention. It is intended that the scope of the invention be defined by the claims appended hereto.

In addition, the previously described versions of the present invention have many advantages, including but not limited to those described above. However, the invention does not require that all advantages and aspects be incorporated into every embodiment of the present invention.

All publications and patent documents cited in this application are incorporated by reference in their entirety for all purposes to the same extent as if each individual publication or patent document were so individually denoted.

What is claimed is:

1. A method of separating oxygen from a gaseous mixture comprised of oxygen with a global exothermic reaction, the method comprising:
heating an initial oxygen carrier in a reducing reactor to a reducing temperature sufficient to generate a reduction reaction, where the reduction reaction reduces the initial oxygen carrier to a carrier product and a liberated oxygen, and where the reduction reaction requires an endothermic heat, and where the reducing temperature is less than the thermolysis temperature of the initial oxygen carrier and less than the thermolysis temperature of the carrier product;
maintaining a partial pressure of oxygen in the reducing reactor below the equilibrium partial pressure of oxygen over the initial oxygen carrier at the reducing temperature by introducing a sweeping flow into the reducing reactor, thereby generating the liberated oxygen;
discharging an oxygen stream from the reducing reactor, where the oxygen stream is comprised of some portion of the liberated oxygen and some portion of the sweeping flow;
transferring the carrier product from the reducing reactor to a fuel reactor, and introducing a fuel stream to the fuel reactor;
maintaining the fuel reactor at a combustion temperature sufficient to cause combustion oxygen comprising at least a portion of the carrier product to react with at least a portion of the fuel stream, thereby generating a oxygen acceptor and combustion products and a combustion heat requirement, where the combustion heat requirement may be endothermic or exothermic, and where the oxygen acceptor is comprised of the at least a portion of the carrier product less the combustion oxygen, and where the combustion temperature is less than the pyrolysis temperature of the carrier product and less than the pyrolysis temperature of the oxygen acceptor;
transferring the oxygen acceptor from the reducing reactor to an oxidizing reactor at an oxidizing temperature sufficient to generate an oxidation reaction, where the oxidation reaction oxidizes the oxygen acceptor to produce a regenerated acceptor, and where the regenerated acceptor has the same composition as the initial metal oxide, and where the oxidation reaction releases an exothermic heat, and where the oxidizing temperature is less than the pyrolysis temperature of the oxygen acceptor and less than the pyrolysis temperature of the regenerated acceptor;
maintaining the partial pressure of oxygen in the oxidizing reactor above the equilibrium partial pressure of oxygen over the oxygen acceptor at the oxidizing temperature by introducing a flow of the gaseous mixture comprised of oxygen into the oxidizing reactor, thereby producing the regenerated acceptor; and
transferring the regenerated acceptor to the reducing reactor and repeating the heating the initial oxygen carrier step by utilizing the regenerated acceptor as the initial oxygen carrier, thereby separating oxygen from the gaseous mixture comprised of oxygen with the global exothermic reaction, where the global exothermic reaction releases a heat comprised of the combination of the endothermic heat, the exothermic heat, and the combustion heat requirement.

2. The method of claim 1 where the initial oxygen carrier is CuO, the carrier product is Cu₂O, the oxygen acceptor is Cu, and the regenerated acceptor is CuO.

3. The method of claim 2 where the reducing temperature is from about 850° C. to about 1150° C., and where the oxidizing temperature is from about 850° C. to about 1150° C., and where the partial pressure of oxygen in the reducing reactor is less than about 76 Torr.

4. The method of claim 1 where the sweeping flow is comprised of CO₂, the oxygen stream is comprised of O₂ and CO₂, and the oxygen stream provides oxygen for an oxy-fuel combustion, comprising:
introducing the oxygen stream and a carbonaceous fuel to a combustion zone at a temperature at least equal to the combustion temperature of the carbonaceous fuel, thereby combusting the carbonaceous fuel and producing a flue gas stream comprised of CO₂; and
discharging the flue gas stream from the combustion zone and generating a recirculation stream, where the recirculation stream is comprised of some portion of the flue gas stream, and repeating the heating the initial oxygen carrier step by utilizing the recirculation stream as the sweeping flow.

5. The method of claim 4 where the oxygen stream is introduced to the combustion zone at a specific CO₂/O₂ ratio, comprising:
generating the recirculation stream at a specific flowrate, where the specific flowrate is sufficient to maintain the partial pressure of oxygen in the reducing reactor below the equilibrium partial pressure of oxygen over the initial oxygen carrier at the reducing temperature; and
providing the sweeping flow to the reducing reactor at the specific flowrate, thereby generating the oxygen stream at the specific CO₂/O₂ ratio.

6. The method of claim 1 where the gaseous mixture comprised of oxygen is air.

7. The method of claim 1 including transferring heat from the oxidizing reactor to the reduction reactor.

8. The method of claim 1 including transferring heat from the oxidizing reactor and the fuel reactor to one or more heat absorbing loads.

9. The method of claim 1 where the sweeping flow is comprised of steam, such that the oxygen stream is comprised of the some portion of the liberated oxygen and an H₂O constituent, and further comprising removing some portion of the H₂O constituent, thereby increasing the oxygen concentration in the oxygen stream.

10. The method of claim 1 where the combustion oxygen is released from the carrier product in the fuel reactor as gaseous oxygen prior to reacting with at least a portion of the fuel stream.

11. A method of separating oxygen from air with a global exothermic reaction, the method comprising:
heating an initial oxygen carrier comprised of CuO in a reducing reactor to a reducing temperature sufficient to generate a reduction reaction, where the reduction reaction reduces the initial oxygen carrier to a carrier product comprised of Cu₂O and a liberated oxygen, and where the reduction reaction requires an endothermic heat, and where the reducing temperature is less than the thermolysis temperature of the initial oxygen carrier and less than the thermolysis temperature of the carrier product;
maintaining a partial pressure of oxygen in the reducing reactor below the equilibrium partial pressure of oxygen over the initial oxygen carrier at the reducing temperature by introducing a sweeping flow into the reducing reactor, thereby generating the liberated oxygen;
discharging an oxygen stream from the reducing reactor, where the oxygen stream is comprised of some portion of the liberated oxygen and some portion of the sweeping flow;
transferring the carrier product from the reducing reactor to a fuel reactor, and introducing a fuel stream to the fuel reactor;
maintaining the fuel reactor at a combustion temperature sufficient to cause combustion oxygen comprising at least a portion of the carrier product to react with at least a portion of the fuel stream, thereby generating combustion products and a oxygen acceptor comprised of Cu, and thereby releasing a combustion heat, where the combustion temperature is less than the pyrolysis temperature of the carrier product and less than the pyrolysis temperature of the oxygen acceptor;
transferring the oxygen acceptor from the reducing reactor to an oxidizing reactor at an oxidizing temperature sufficient to generate an oxidation reaction, where the oxidation reaction oxidizes the oxygen acceptor to produce a regenerated acceptor comprised of CuO, and where the oxidizing temperature is less than the pyrolysis temperature of the oxygen acceptor and less than the pyrolysis temperature of the regenerated acceptor;
maintaining the partial pressure of oxygen in the oxidizing reactor above the equilibrium partial pressure of oxygen over the oxygen acceptor at the oxidizing temperature by introducing a flow of air into the oxidizing reactor, thereby producing the regenerated acceptor; and
transferring the regenerated acceptor to the reducing reactor and repeating the heating the initial oxygen carrier step by utilizing the regenerated acceptor as the initial oxygen carrier, thereby separating oxygen from air with the global exothermic reaction, where the global exothermic reaction releases a heat comprised of the combination of the endothermic heat, the exothermic heat, and the combustion heat.

12. The method of claim 11 where the reducing temperature is from about 850° C. to about 1150° C., and where the oxidizing temperature is from about 850° C. to about 1150° C., and where the partial pressure of oxygen in the reducing reactor is less than about 76 Torr.

13. The method of claim 1 where the sweeping flow is comprised of CO₂, the oxygen stream is comprised of O₂ and CO₂, and the oxygen stream provides oxygen for an oxy-fuel combustion, comprising:
introducing the oxygen stream and a carbonaceous fuel to a combustion zone at a temperature at least equal to the combustion temperature of the carbonaceous fuel, thereby combusting the carbonaceous fuel and producing a flue gas stream comprised of CO₂; and
discharging the flue gas stream from the combustion zone and generating a recirculation stream, where the recirculation stream is comprised of some portion of the flue gas stream, and repeating the heating the initial oxygen carrier step by utilizing the recirculation stream as the sweeping flow.

14. The method of claim 4 where the oxygen stream is introduced to the combustion zone at a specific CO₂/O₂ ratio, comprising:
generating the recirculation stream at a specific flowrate, where the specific flowrate is sufficient to maintain the partial pressure of oxygen in the reducing reactor below the equilibrium partial pressure of oxygen over the initial oxygen carrier at the reducing temperature; and
providing the sweeping flow to the reducing reactor at the specific flowrate, thereby generating the oxygen stream at the specific CO₂/O₂ ratio.

15. The method of claim 11 including transferring heat from the oxidizing reactor to the reduction reactor.

16. The method of claim 11 where the sweeping flow is comprised of steam, such that the oxygen stream is comprised of the some portion of the liberated oxygen and an H₂O constituent, and further comprising removing some portion of the H₂O constituent, thereby increasing the oxygen concentration in the oxygen stream.

17. The method of claim 11 where the combustion oxygen is released from the carrier product in the fuel reactor as gaseous oxygen prior to reacting with at least a portion of the fuel stream.

18. A method of separating oxygen from air with a global exothermic reaction, the method comprising:
heating an initial oxygen carrier comprised of CuO in a reducing reactor to a reducing temperature from about 850° C. to about 1150° C. sufficient to generate a reduction reaction, where the reduction reaction reduces the initial oxygen carrier to a carrier product comprised of Cu₂O and a liberated oxygen, and where the reduction reaction requires an endothermic heat, and where the reducing temperature is less than the thermolysis temperature of the initial oxygen carrier and less than the thermolysis temperature of the carrier product;
maintaining a partial pressure of oxygen in the reducing reactor of less than about 76 Torr by introducing a sweeping flow comprised of CO₂ into the reducing reactor, thereby generating the liberated oxygen;
discharging an oxidizer stream from the reducing reactor, where the oxidizer stream is comprised of some portion of the liberated oxygen and some portion of the CO₂ comprising the sweeping flow, and utilizing the oxidizer stream to maintain the sweeping flow by,
introducing the oxidizer stream and a carbonaceous fuel to a combustion zone at a temperature at least equal to the combustion temperature of the carbonaceous fuel, thereby combusting the carbonaceous fuel and producing a flue gas stream comprised of CO₂, and
discharging the flue gas stream from the combustion zone and generating a recirculation stream, where the recirculation stream is comprised of some portion of the flue gas stream, and utilizing some portion of the recirculation stream as the sweeping flow;
transferring the carrier product from the reducing reactor to a fuel reactor, and introducing a fuel stream to the fuel reactor, where the fuel stream is comprised of a hydrocarbon fuel;
maintaining the fuel reactor at a combustion temperature sufficient to cause combustion oxygen comprising at least a portion of the carrier product to react with at least a portion of the hydrocarbon fuel, thereby generating combustion products and a oxygen acceptor comprised of Cu, and thereby releasing a combustion heat, where the combustion temperature is less than the pyrolysis temperature of the carrier product and less than the pyrolysis temperature of the oxygen acceptor;
transferring the oxygen acceptor from the reducing reactor to an oxidizing reactor at an oxidizing temperature from about 850° C. to about 1150° C. sufficient to generate an oxidation reaction, where the oxidation reaction oxidizes the oxygen acceptor to produce a regenerated acceptor comprised of CuO;
maintaining the partial pressure of oxygen in the oxidizing reactor above the equilibrium partial pressure of oxygen over the oxygen acceptor at the oxidizing temperature by introducing a flow of air into the oxidizing reactor, thereby producing the regenerated acceptor; and
transferring the regenerated acceptor to the reducing reactor and repeating the heating the initial oxygen carrier step by utilizing the regenerated acceptor as the initial oxygen carrier, thereby separating oxygen from air with the global exothermic reaction, where the global exothermic reaction releases a heat comprised of the combination of the endothermic heat, the exothermic heat, and the combustion heat.

19. The method of claim 18 including transferring heat from the oxidizing reactor to the reduction reactor.

20. The method of claim 19 where the combustion oxygen is released from the carrier product in the fuel reactor as gaseous oxygen prior to reacting with at least a portion of the fuel stream.
